(19) United States
(12) Patent Application Publication
(10) Pub. No.: US 2026/0221469 A1
(43) Pub. Date: Jul. 30, 2026

(54) METHOD FOR PREPARING FUEL CELL CATALYST COMPRISING POROUS CARRIER HAVING ADJUSTED PHYSICAL PROPERTIES, FUEL CELL CATALYST, AND MEMBRANE-ELECTRODE ASSEMBLY

(71) Applicant: KOLON INDUSTRIES, INC., Seoul (KR)

(72) Inventors: Jung Ho KIM, Seoul (KR); Jun Young KIM, Seoul (KR); Kah Young SONG, Seoul (KR); Nak Won KONG, Seoul (KR); Eun Su LEE, Seoul (KR); Hyeong Su KIM, Seoul (KR); Kyoung Sik NAM, Seoul (KR); Chan Mi PARK, Seoul (KR); Ju Sung LEE, Seoul (KR)

(21) Appl. No.: 19/139,473

(22) PCT Filed: Feb. 16, 2023
(86) PCT No.: PCT/KR2023/002251

§ 371 Date: Jun. 16, 2025

(30) Foreign Application Priority Data
Mar. 17, 2022 (KR) 10-2022-0033391

(51) Int. Cl. H01M 4/92; H01M 4/88; H01M 8/1004

(52) U.S. Cl. CPC H01M 4/926; H01M 4/8817; H01M 8/1004

(57) ABSTRACT

The present disclosure relates to a method for manufacturing a fuel cell catalyst comprising a porous carrier having adjusted physical properties, a fuel cell catalyst, and a membrane-electrode assembly and, more specifically, to a method for manufacturing a fuel cell catalyst, a fuel cell catalyst, and a membrane-electrode assembly, the method comprising: a first step of preparing a porous carrier; and a second step of manufacturing a fuel cell catalyst by supporting a metal catalyst on the porous carrier of the first step, wherein the porous carrier has specific pore physical properties.

### TECHNICAL FIELD

The present disclosure relates to a method of manufacturing a fuel cell catalyst, a fuel cell catalyst, and a membrane-electrode assembly, the catalyst including a porous support having adjusted physical properties, and more particularly, to a method of manufacturing a fuel cell catalyst using a porosity-controlled porous support, a fuel cell catalyst, and a membrane-electrode assembly, the catalyst including a porous support having adjusted physical properties.

### BACKGROUND ART

Recently, due to an environmental pollution caused by an excessive use of fossil fuels, and a rapid increase in a price of oil, there has been a growing interest in fuel cells with low emissions of environmental pollutants, and high energy efficiency. Fuel cells directly convert chemical energy of raw materials into electric energy using electrochemical conversion methods, without converting the chemical energy into a mechanical energy. Fuel cells are based on an opposite principle of water electrolysis. In water electrolysis, water is decomposed into hydrogen and oxygen using external electricity, while fuel cells generate electricity by electrochemically reacting hydrogen and oxygen. A chemical reaction equation relating this procedure is given by Chemical Equation (1) and (2) below:

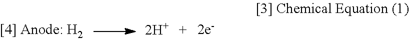

A reaction at an anode is an oxidation reaction, and oxidation of hydrogen occurs easily on a catalyst composed of platinum. An anode catalyst of low-temperature fuel cells needs to oxidize hydrogen, and in a real system, the fuel may contain CO, S or NH₃, etc. rather than pure hydrogen. Among them, CO is a main toxic substance in low-temperature fuel cells, and it is easily adsorbed on platinum catalysts. Carbon monoxide adsorbed on platinum catalysts attaches to active points of the catalysts, reducing a reaction area with hydrogen, and degrading performance of the catalysts. To reduce damage caused by carbon monoxide, CO needs to be oxidized to CO₂.

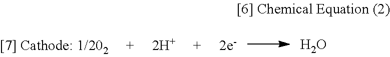

A reaction at a cathode is a reduction reaction where electrons pass through an electrolyte to the anode, and combine again with an oxidized hydrogen to form water. Cathodes have been widely studied due to the superiority of platinum-based catalysts which exert a best performance at reducing oxygen. To compensate for reduced reactivity due to a low temperature operation, it is preferable that a high amount of metal is added for oxygen catalysis, and this type of fuel cell also uses air as a cathode gas, and in this case a partial pressure of oxygen is reduced than that of a pure oxygen, which reduces reaction activity. Porosity of a cathode layer can be optimized by adding pore-forming materials.

Fuel cells are classified as a polymer electrolyte fuel cell (PEMFC), a solid oxide fuel cell (SOFC), and a molten carbonate fuel cell (MCFC), etc. according to fuel or materials. A fuel cell power generation unit consists of a Fuel Reformer, which is a device that converts hydrogen-containing common fuels (LPG, LNG, methane, coal gas methanol, etc.) into hydrogen-rich gas required by fuel cells; a Stack, which generates direct current electricity, water, and heat as byproducts from oxygen in air, and hydrogen coming from the Fuel Reformer; and an Inverter, which converts direct current power from fuel cells into alternating current power. The most important part of the stack is a membrane-electrode assembly. The Membrane Electrode Assembly (MEA) is a film-like assembly that is responsible for driving a chemical reaction between oxygen and hydrogen, and converting chemical energy resulting from the chemical reaction into an electrical energy. Hydrogen and oxygen supplied to the fuel cells become ions releasing electrons at a cathode and an anode, respectively, and the electrons escape to the outside as an electric current. This reaction takes place at the film-electrode assembly. The film-electrode assembly consists of an electrolyte film, an anode, and a cathode.

Porous carbons have long attracted attention as catalyst supports because of their diverse pore structure, stability in acidic and basic atmospheres, low cost, and ease of fabrication and processing. Porous carbons with regular pore size and structure have many advantages as catalyst supports, but further research is needed to control physical properties of porous carbons to improve performance of fuel cells.

In particular, an electrochemical surface area (ECSA) of a catalyst metal can be reduced due to corrosion and agglomeration of a carbon-based support that occurs during the operation of fuel cells, and when such an electrode catalyst is used, activity and durability of the electrode catalyst can be reduced. Therefore, alleviating such an issue is required.

### RELATED ART DOCUMENTS

### Patent Documents

(Patent Document 1) Korean Patent Registered Publication No. 10-1985064
(Patent Document 2) Korean Patent Registered Publication No. 10-1238887
(Patent Document 3) Korean Patent Registered Publication No. 10-1473319
(Patent Document 4) Korean Patent Registered Publication No. 10-0665689

### Non-Patent Documents

(Non-Patent Document 1) “Ordered mesoporous carbons (OMC) as supports of electrocatalysts for direct methanol fuel cells (DMFC): Effect of carbon precursors of OMC on DMFC performances”, Received 9 Nov. 2005; received in revised form 15 Feb. 2006; accepted 5 Mar. 2006 Available online 15 May 2006

(Non-Patent Document 2) “Platinum-supported mesoporous carbon (Pt/CMK-3) as anodic catalyst for direct methanol fuel cell applications: The effect of preparation and deposition methods”, Progress in Natural Science: Materials International 2012; 22(6):616-623

### DISCLOSURE

### Technical Problem

The present disclosure aims to solve the above problems, and to provide a fuel cell catalyst including a porous support, and a method of preparing the same, the catalyst having improved mass transfer by manufacturing a porous support with satisfactory physical properties, or by controlling physical properties of a porous support to a certain range through post-treatment.

### Technical Solution

In an embodiment of the present disclosure, a method of manufacturing a fuel cell catalyst, wherein the catalyst includes a porous support having adjusted physical properties, and the method includes a first step of preparing a porous support; and a second step of manufacturing a fuel cell catalyst by embedding a metal catalyst in the porous support of the first step, wherein among pores of the porous support, a unit volume of pores with a size of 4 to 8 nm is between 0.40 and 1.00 cm³/g, BET specific surface area of the pores with a size of 4 to 8 nm is 300 to 700 m²/g, and a proportion of corresponding pores (S) in a total BET specific surface area is 50 to 90%; a unit volume of pores with a size of less than 4 nm is 0.02 to 0.20 cm³/g, BET specific surface area of the pores with a size of less than 4 nm is 10 to 80 m²/g, and a proportion of corresponding pores (S) in a total BET specific surface area is less than 0 to 10%; and a unit volume of pores with a size of more than 8 nm is 0.20 to 2.20 cm³/g, BET specific surface area of the pores with a size of more than 8 nm is 40 to 400 m²/g, and a proportion of corresponding pores (S) in a total BET specific surface area is 10 to 40%.

In the porous support of the first step, the physical properties may be controlled by any one or a combination of two or more methods selected from a group consisting of a physical particle size control by a bead mill, or an ultrasonication; an acid treatment; a heat treatment; and an activation treatment.

The porous support of the first step may be any one or mixtures of two or more of carbon-based supports, metal oxides, metal nitrides, and metal oxides.

One embodiment of the present disclosure is a fuel cell catalyst including a porous support, and a metal catalyst, wherein among pores of the porous support, a unit volume of pores with a size of 4 to 8 nm is between 0.40 and 1.00 cm³/g, BET specific surface area of the pores with a size of 4 to 8 nm is 300 to 700 m²/g, and a proportion of corresponding pores (S) in a total BET specific surface area is 50 to 90%; a unit volume of pores with a size of less than 4 nm is 0.02 to 0.20 cm³/g, BET specific surface area of the pores with a size of less than 4 nm is 10 to 80 m²/g, and a proportion of corresponding pores (S) in a total BET specific surface area is less than 0 to 10%; and a unit volume of pores with a size of more than 8 nm is 0.20 to 2.20 cm³/g, BET specific surface area of the pores with a size of more than 8 nm is 40 to 400 m²/g, and a proportion of corresponding pores (S) in a total BET specific surface area is 10 to 40%.

The porous support may have a main peak (2θ) of a low angle XRD pattern of 0.8 to 3°.

The porous support may have a grain size (L_{C}002) of 2.0 to 4.5 nm.

The porous support may be a carbon-based support, and a tap density of the carbon may be 0.10 to 0.5 g/cm³, and a G/D ratio of the carbon may be 0.7 to 1.3.

The metal catalyst may be distributed and embedded in the porous support, and the amount of the embedded metal catalyst may be from 10 to 80% by weight of a total weight of the catalyst.

The metal catalyst may be any one, or mixtures of two or more selected from a group consisting of Pt, PtRu, PtIr, PtCo, PtNi, PtY, PtCoN, and PtCoMn.

The porous support may have a bimodal or trimodal morphology with a single type of pore, or different types of pores.

In one embodiment of the present disclosure, a membrane-electrode assembly includes a fuel cell catalyst of the present disclosure.

### Advantageous Effects

As described above, the present disclosure has an effect of improving mass transfer by controlling a porosity of a porous support, and improving performance by enhancing catalyst utilization.

Furthermore, the present disclosure has an effect of improving durability of a catalyst by improving distribution of the catalyst through controlling a porosity of a porous support.

### DESCRIPTION OF DRAWINGS

FIG. 1 is a flowchart of a method of manufacturing a fuel cell catalyst, the catalyst including a porous support having adjusted physical properties, according to an embodiment of the present disclosure; and

FIG. 2 is a fuel cell performance evaluation result of a catalyst prepared using supports of Examples and Comparative Examples of the present disclosure.

### BEST MODE

In the drawings shown below, like reference numerals refer to like components, and a size of each component in the drawings may be exaggerated for clarity and convenience of description. The embodiments described herein are exemplary only, and various modifications of these embodiments are possible. As used herein, terms are used only for the purpose of distinguishing one component from another. Expressions of a singular include a plural unless the context clearly indicates otherwise. Also, when a portion is said to “include” a component, it is meant to be inclusive of other components, not exclusive of other components, unless specifically noted to the contrary.

As used herein, a “physical property” of a porous support may be any one or more selected from a group consisting of a unit volume of pores, a BET specific surface area, a main peak (2θ) of a low angle XRD pattern, a grain size (LC002), a tap density of carbon, a G/D ratio, and the like, and each physical property of the porous support controlled by the present disclosure is described in the respective embodiments of the present disclosure.

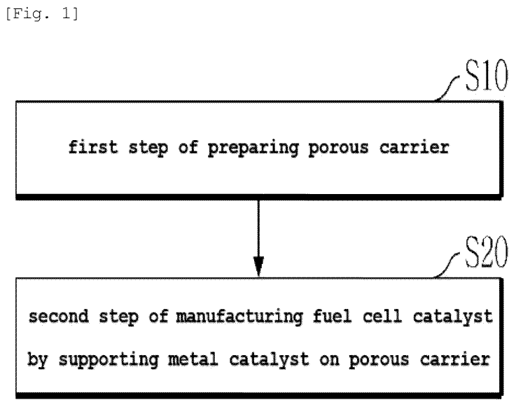

Hereinafter, a method of manufacturing a fuel cell catalyst including a porous support having adjusted physical properties, according to the present disclosure, will be described in detail. FIG. 1 is a flowchart of a method of manufacturing a fuel cell catalyst, the catalyst including a porous support having adjusted physical properties, according to one embodiment of the present disclosure. Referring to FIG. 1, a method of manufacturing a fuel cell catalyst, the catalyst including a porous support having adjusted physical properties, according to the present disclosure includes the following steps:
a first step (S10) of preparing a porous support; and
a second step (S20) of manufacturing a fuel cell catalyst by embedding a metal catalyst in the porous support of the first step (S10),
wherein among pores of the porous support, a unit volume of pores with a size of 4 to 8 nm is between 0.40 and 1.00 cm³/g, BET specific surface area of the pores with a size of 4 to 8 nm is 300 to 700 m²/g, and a proportion of corresponding pores (S) in a total BET specific surface area is 50 to 90%; a unit volume of pores with a size of less than 4 nm is 0.02 to 0.20 cm³/g, BET specific surface area of the pores with a size of less than 4 nm is 10 to 80 m²/g, and a proportion of corresponding pores (S) in a total BET specific surface area is less than 0 to 10%; and a unit volume of pores with a size of more than 8 nm is 0.20 to 2.20 cm³/g, BET specific surface area of the pores with a size of more than 8 nm is 40 to 400 m²/g, and a proportion of corresponding pores (S) in a total BET specific surface area is 10 to 40%.

The porous support of the present disclosure preferably satisfies all of the above conditions, and the unit volume of the pores can be calculated by a BJH calculation method, following controlling the above range of the pores after BET measurement.

In general, porous supports can be categorized based on the types of pores they contain; micropores, mesopores, and macropores according to a diameter size of pores. Herein, the micropore refers to a pore having an average diameter of 2 nm or less, in particular 0.01 to 2 nm, the mesopore refers to a pore having an average diameter of more than 2 nm and at least 50 nm, and the macropore refers to a pore having an average diameter of more than 50 nm, in particular more than 50 nm and at least 500 nm. Accordingly, the porous support having adjusted physical properties, according to the present disclosure is used in a form of a support having mesopores, and it is preferred that the pores of the porous supports have a size of 4 to 8 nm, for example, among the above ranges of a size of a mesopore.

It is preferable to use a porous support of the present disclosure, the porous support having a pore occupancy of 50 to 90% relative to its total surface area, with pore sizes between 4 to 8 nm. The pore occupancy can be obtained by dividing the surface area occupied by those pores of the porous support by the total surface area. When the above pore occupancy is satisfied, the predominant pores are mesopores, the more mesopores there are, the more favorable the characteristics in terms of improving a performance of fuel cells.

Further, according to the present disclosure, the porous support having adjusted physical properties may have a total specific surface area (BET) in a range of 100 to 1,000 m²/g. Preferably, the porous support having adjusted physical properties may include a mesoporous support having a specific surface area (BET) in a range of 200 to 800 m²/g. In this case, when the specific surface area of the porous support is less than 200 m²/g, there may be a problem that it is difficult to achieve high distribution of an active metal, and when the specific surface area of the porous support is more than 800 m²/g, there may be a problem that a proportion of mesopores decreases, and a proportion of micropores increases, and therefore the above range of 200 to 800 m²/g is suitable.

Furthermore, the pores of the porous support having adjusted physical properties, according to the present disclosure may be in a form of bimodal, trimodal, having a single type, or two or more types of pore.

The first step (S10) is a step to prepare a porous support, the porous support being able to be used as one of, or mixtures of two or more of carbon-based supports, metal oxides, metal nitrides, and metal carbides.

The carbon-based support of the present disclosure is not particularly limited, but at least one selected from a group consisting of an activated carbon, a carbon black, a graphite, a graphene, an ordered mesoporous carbon (OMC), and a carbon nanotube can be used. Preferably, it may be a carbon black with a high percentage of mesopores in the total pores, in a specific example, the activated carbon may be selected from a group consisting of SX ULTRA, CGSP, PK1-3, SX 1G, DRACO S51HF, CA-1, A-51, GAS 1240 PLUS, KBG, CASP, and SX PLUS, and the carbon black may be, but is not limited to, BLACK PEARLS, ELFTEX, VULCAN, MOGU, MONARCH, EMPEROR, and REGAL.

The porous support of the first step (S10) may be subjected to a hard or soft template replication method following preparing the porous support by a proper treatment after adding precursors to templates, but not limited to, and the porous support prepared by such a method may be a mesoporous support.

Specifically, the hard template method is a method including steps of injecting precursors into a hard template, such as mesoporous silica, followed by oxidizing, reducing, polymerizing, or carbonizing the precursors to produce a replicated form of precursors, and then removing the template to produce a final product, and the soft template method is a method including steps of using a template that has a specific shape, but is not hard, followed by oxidizing, reducing, polymerizing, or carbonizing precursors to produce a replicated form of the precursors, and then removing the template using a surfactant to produce a final product.

The metal oxides of the present disclosure may be one, or mixtures of two or more selected from yttrium oxide (Y₂O₃), aluminum oxide (Al₂O₃), magnesium oxide (MgO), zinc oxide (ZnO), tin oxide (SnO), indium oxide (In₂O₃), iron oxide (FeO), titanium oxide (TiO₂), zirconium oxide (ZrO₂), chromium oxide (Cr₂O₃), hafnium oxide (HfO), and beryllium oxide (BeO).

The metal nitrides of the present disclosure may be one, or mixtures of two or more selected from a group consisting of niobium nitride, tin nitride, indium nitride, platinum nitride, tantalum nitride, zirconium nitride, copper nitride, iron nitride, tungsten nitride, chromium nitride, molybdenum nitride, hafnium nitride, titanium nitride, vanadium nitride, cobalt nitride, manganese nitride, cerium nitride, mercury nitride, plutonium nitride, platinum nitride, gold nitride, silver nitride, iridium nitride, palladium nitride, yttrium nitride, ruthenium nitride, lanthanum nitride, cerium nitride, praseodymium nitride, neodymium nitride, promethium nitride, samarium nitride, europium nitride, dolomium nitride, terbium nitride, dysprosium nitride, holmium nitride, erbium nitride, thulium nitride, ytterbium nitride, ruthenium nitride, and nickel nitride.

As the metal carbides of the present disclosure, one, or mixtures of two or more selected from a group consisting of SiC, B₄C, TiC, CrC, MoC, WC, NbC, and NiC may be used.

The first step may further include controlling the physical properties of the porous support. Controlling the physical properties may be performed by any one, or a combination of two or more methods selected from, for example, a physical particle size control via a bead mill, an ultrasound, or the like, an acid treatment, a heat treatment, and an activation treatment. The acid treatment, heat treatment, activation treatment, etc. may be performed by any method known in the art, and the treatment method may be selected and used depending on the desired physical properties, and the physical properties may be controlled by a combination of methods as needed. For example, a porosity is basically formed when a part used as a template is removed, further heat treatment such as graphitization is performed on the carbon, or an activation treatment such as water vapor, or carbon dioxide activation treatment is performed, and these treatment conditions are appropriately controlled, which can control the physical properties of the porous support.

The porous support with the controlled physical properties, according to the present disclosure, can be subjected to a separate acid treatment. For example, the porous support may be post-treated with an aqueous solution of nitric acid (HNO₃), wherein the aqueous solution of nitric acid (HNO₃) may include from 1 to 50 parts by weight of nitric acid per 100 parts by weight of a total aqueous solution, and the post-treatment may be performed at a temperature range of 50 to 150° C. for 1 to 10 hours.

In one aspect, the porous support may have a main peak 2θ of a low angle XRD pattern of 0.8 to 3°. In this case, a measurement method of the main peak (2θ) of the low angle XRD pattern is the same as the XRD analysis method, but only analyzes the 2θ value from 0.1 to 10°, and is useful for analyzing a mesoporous structural material of the porous support of the present disclosure. When the main peak (2θ) value is less than 0.8°, the size of the main pores tends to increase, which may not satisfy an intended physical properties of the present disclosure, and when the main peak (2θ) value is more than 3°, an opposite tendency of the main pores to become smaller, close to micro-pores, may not satisfy the intended physical properties of the present disclosure.

Furthermore, it is preferred to use a porous support having a grain size (L_{C}002) of 2.0 to 4.5 nm. Here, the grain size can be calculated by a Scherrer equation for the 002 facet peak of carbon after XRD analysis. When the grain size of the porous support is less than 2.0 nm, a durability of the support may be reduced, and when the grain size of the porous support is more than 4.5 nm, durability of the support may be difficult to uniformly embed a metal catalyst due to a hard support surface, and the metal catalyst may have difficulty in bonding with the support, which may reduce durability of the catalyst.

Although carbon-based supports, metal oxides, metal nitrides, and metal carbides can be used as a porous support in the present disclosure, the carbon-based support may be predominantly used. When the carbon-based support is used as a porous support, in addition to the above physical properties, a tap density of carbon may be 0.10 to 0.5 g/cm³, more preferably 0.12 to 0.48 g/cm³, and the G/D ratio may be 0.7 to 1.3, preferably 0.8 to 1.28. When the porous support, i.e., the porous support has the tap density of carbon of less than 0.10 g/cm³, the support is not compatible with a solvent, which makes the support less dispersible in the solvent, and when the tap density of carbon is more than 0.5 g/cm³, it may be difficult to embed a metal catalyst in the support uniformly because of reduced distribution due to a cohesion between the supports.

In addition, a porous support, i.e., the support with a G/D ratio of a carbon of less than 0.7, is less durable, and the support with a G/D ratio of carbon of more than 1.3 is less durable because of a difficulty in uniformly embedding the catalyst due to a hard support surface, and difficulty in binding the catalyst to the support.

The second step (S20) is a step to prepare a fuel cell catalyst by embedding a metal catalyst in the porous support of the first step (S10). As a metal catalyst used in the present disclosure, one, or a mixtures of two or more selected from a group consisting of Pt, PtRu, PtIr, PtCo, PtNi, PtY, PtCoNi, and PtCoMn can be used.

Preferably, an amount of the metal catalyst embedded in the second step is 10 to 80 wt %, because when the amount of the metal catalyst is below the above-specified range, a thickness of an electrode layer relatively increases, which reduces a performance, and when the amount of the metal catalyst is beyond the above-specified range, it may be economically disadvantageous, and the catalyst particle size may increase. In view of these points, the amount of the metal catalyst embedded in the above-mentioned catalyst is preferably 10 to 80 wt %. The amount of the metal catalyst embedded, according to the present disclosure can be obtained by TGA analysis.

The present disclosure can provide a membrane-electrode assembly using a catalyst layer for a fuel cell obtained by a method of manufacturing a fuel cell catalyst, the catalyst including a porous support having adjusted physical properties. The membrane-electrode assembly (MEA) of the present disclosure may include a proton exchange membrane, a catalyst layer for fuel cells, and a gas diffusion layer (GDL). When the MEA is prepared using a porous support for fuel cells, the support having adjusted physical properties, being included in the catalyst layer, a porosity of the porous support is optimally controlled, resulting in an improved mass transfer, and enhanced catalyst utilization.

### MODE FOR INVENTION

### Example 1

10 g of template of ordered mesoporous silica (whose pore size is about 15 nm) was injected with 5 g of carbon precursors (phenolic resin) at 120° C. for 1 h by a gas phase adsorption, and then heated at 160° C. for 2 h to polymerize. Resulting silica-polymer composites were subjected to an ultrasonication to control a physical particle size, excess polymerized polymers were removed, carbonized at a temperature of 1,000° C. under an Ar atmosphere for 6 h, followed by a graphitization at 2,000° C. for 2 h, and a wet etching using NaOH or KOH to prepare porous graphitized carbon supports satisfying physical properties shown in Table 1 below.

### Example 2

The porous graphitized carbon supports prepared by Example 1 were subjected to a water vapor post-treatment at 400° C. for 2 hours to prepare porous graphitized carbon supports satisfying physical properties shown in Table 1 below.

### Comparative Example 1

Commercial Vulcan XC-72 carbon.

### Comparative Example 2

Mesoporous carbon (CMK-3) was prepared by filling pores of conventional SBA-15 silica template (whose pore size is 7.5 nm) with carbon precursors at 1.1 to 1.7 times by a volume of the template, and removing the template following a heat treatment at 1,000° C. under an Ar atmosphere.

### Comparative Example 3

Pores of a conventional SBA-15 silica (whose pore size is 7.5 nm) were filled with carbon precursors at 1.1 to 1.7 times by a volume of a template, and the precursors were carbonized at a temperature of 1,000° C. for 6 hours under an Ar atmosphere, graphitized at 2,000° C. for 2 hours, and the template was removed to prepare porous graphitized carbon supports. Resulting porous graphitized carbon supports were ground in a bead mill for 30 minutes to prepare post-treated porous graphitized carbon supports.

### Physical Properties of Carbon Supports

TABLE 1

| | Pore Volume | | | | BET Surface Area | | | | L-XRD | | Tap | |
|---|---|---|---|---|---|---|---|---|---|---|---|---|
| | (cm³/g) | | | | (m²/g). (ratio %) | | | | Peak | Lc | Density | G/D |
| Sample | <4 nm | 4-8 nm | >8 nm | Total | <4 nm | 4-8 nm | >8 nm | Total | deg. | 002 nm | g/cm³ | ratio |
| Example 1 | 0.02 | 0.53 | 0.81 | 1.36 | 20 | 300 | 80 | 400 | 1.8 | 3.62 | 0.27 | 1.22 |
| | | | | | (5%) | (75%) | (20%) | | | | | |
| Example 2 | 0.04 | 0.71 | 1.25 | 2.00 | 60 | 450 | 170 | 680 | 1.0 | 2.83 | 0.19 | 0.94 |
| | | | | | (8.8%) | (66.2%) | (25%) | | | | | |
| Comparative | 0.22 | 0.10 | 0.29 | 0.61 | 170 | 54 | 16 | 240 | 2.8 | 2.87 | 0.31 | 0.95 |
| Example 1 | | | | | (70.8%) | (22.5%) | (6.7%) | | | | | |
| Comparative | 0.11 | 0.30 | 0.48 | 0.89 | 180 | 504 | 200 | 884 | 0.97 | 1.86 | 0.09 | 0.49 |
| Example 2 | | | | | (20.4%) | (57%) | (22.6%) | | | | | |
| Comparative | 0.03 | 0.45 | 2.22 | 2.70 | 46 | 210 | 415 | 671 | 1.2 | 3.22 | 0.25 | 1.03 |
| Example 3 | | | | | (6.9%) | (31.3%) | (61.8%) | | | | | |

Examples satisfied all the physical properties required by the present disclosure, and the Comparative Example 1 had inadequate physical properties in terms of a pore volume of pores<4 nm in size, a pore volume of pores 4 to 8 nm in size, total BET specific surface area, and a proportion of the above-mentioned pores relative to a total BET specific surface area, and the Comparative Example 2 had inadequate physical properties in terms of BET specific surface area of pores<4 nm in size, and a proportion of the above-mentioned pores relative to a total BET specific surface area, a L_{C}002 crystallite size, a Tap density, and a G/D ratio. In addition, the Comparative Example 3 had inadequate physical properties in terms of a BET specific surface area of pores between 4 and 8 nm in size, an unit volume, and a BET specific surface area of pores>8 nm in size. Compared to Comparative Examples 1 to 3, Example 1 was improved in terms of a distribution of the catalyst, and durability of the catalyst.

### Preparative Example

The carbons of the above Examples and Comparative Examples were utilized to prepare catalysts embedded with 50% Pt by a polyol reduction method.

### Evaluation Example: Evaluation of Cell Performance Under Conditions of 80° C. And RH 50%

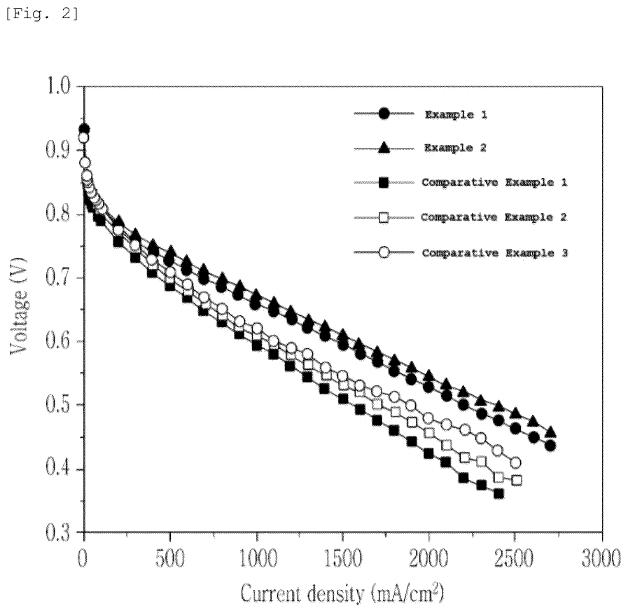

A fuel cell was fabricated using the catalyst of the Example 1, and the cell performance was evaluated. Results are shown in FIG. 2. It can be seen from FIG. 2 that the catalysts of the Examples according to the present disclosure prepared utilizing a support having adjusted physical properties exhibit superior performance compared to that of the catalysts of the Comparative Examples.

The present disclosure is not limited to the above Examples, but may be made in a variety of different forms, and one having ordinary skill in the technical field to which the present disclosure belongs will understand that it may be made in other specific forms without altering the technical spirit or essential features of the present disclosure. Therefore, it should be understood that the Examples described above are in all respects illustrative, and not limiting.

1. A method of manufacturing a fuel cell catalyst, the method comprising:
a first step of preparing a porous support; and
a second step of manufacturing a fuel cell catalyst by embedding a metal catalyst in the porous support of the first step,
wherein among pores of the porous support, a unit volume of pores with a size of 4 to 8 nm is between 0.40 and 1.00 cm³/g, BET specific surface area of the pores with a size of 4 to 8 nm is 300 to 700 m²/g, and a proportion of corresponding pores (S) in a total BET specific surface area is 50 to 90%; a unit volume of pores with a size of less than 4 nm is 0.02 to 0.20 cm³/g, BET specific surface area of the pores with a size of less than 4 nm is 10 to 80 m²/g, and a proportion of corresponding pores (S) in a total BET specific surface area is less than 0 to 10%; and a unit volume of pores with a size of more than 8 nm is 0.20 to 2.20 cm³/g, BET specific surface area of the pores with a size of more than 8 nm is 40 to 400 m²/g, and a proportion of corresponding pores (S) in a total BET specific surface area is 10 to 40%.

2. The method of claim 1, wherein the physical properties of the porous support prepared in the first step are controlled by any one or a combination of two or more methods selected from a group consisting of a physical particle size control by a bead mill, or an ultrasonication; acid treatment; heat treatment; and activation treatment.

3. The method of claim 1, wherein the porous support of the first step is any one or mixtures of two or more of carbon-based supports, metal nitrides, and metal oxides.

4. A fuel cell catalyst including a porous support, and a metal catalyst, wherein among pores of the porous support, a unit volume of pores with a size of 4 to 8 nm is between 0.40 and 1.00 cm³/g, BET specific surface area of the pores with a size of 4 to 8 nm is 300 to 700 m²/g, and a proportion of corresponding pores (S) in a total BET specific surface area is 50 to 90%; a unit volume of pores with a size of less than 4 nm is 0.02 to 0.20 cm³/g, BET specific surface area of the pores with a size of less than 4 nm is 10 to 80 m²/g, and a proportion of corresponding pores (S) in a total BET specific surface area is less than 0 to 10%; and a unit volume of pores with a size of more than 8 nm is 0.20 to 2.20 cm³/g, BET specific surface area of the pores with a size of more than 8 nm is 40 to 400 m²/g, and a proportion of corresponding pores (S) in a total BET specific surface area is 10 to 40%.

5. The catalyst of claim 4, wherein the porous support has a main peak (2θ) of a low angle XRD pattern of 0.8 to 3°.

6. The catalyst of claim 4, wherein the porous support has a grain size (L_{C}002) of 2.0 to 4.5 nm.

7. The catalyst of claim 4, wherein the porous support is a carbon-based support, and a tap density of the carbon is 0.10 to 0.5 g/cm³, and a G/D ratio of the carbon is 0.7 to 1.3.

8. The catalyst of claim 4, wherein the metal catalyst is distributed and embedded in the porous support, and the amount of the embedded metal catalyst is from 10 to 80% by weight of a total weight of the catalyst.

9. The catalyst of claim 4, wherein the metal catalyst is any one or mixtures of two or more selected from a group consisting of Pt, PtRu, PtIr, PtCo, PtNi, PtY, PtCoN, and PtCoMn.

10. The catalyst of claim 4, wherein the porous support has a bimodal or trimodal morphology with a single type of pore, or different types of pores.

11. A membrane-electrode assembly comprising a fuel cell catalyst of claim 4.
